(19) United States
(12) Patent Application Publication
(10) Pub. No.: US 2015/0250360 A1
(43) Pub. Date: Sep. 10, 2015

(54) BLENDER

(71) Applicant: Euro-Pro Operating LLC, Newton, MA (US)

(72) Inventor: Eric Daniel Hyp, Yongkang City (CN)

(73) Assignee: Euro-Pro Operating LLC, Newton, MA (US)

(21) Appl. No.: 14/201,771

(22) Filed: Mar. 7, 2014

(51) Int. Cl. A47J 43/046; B01F 15/00; B01F 7/16

(52) U.S. Cl. CPC A47J 43/046; B01F 7/162; B01F 7/1695; B01F 15/00448; B01F 15/00538; B01F 2215/0014; B01F 2015/00597

(57) ABSTRACT

Embodiments disclosed herein are directed to blender where movement of a blender jar assembly is used as part of activating the motor. In some embodiments, the blender jar assembly is held by a blender base without requiring toggling or activation of a switch or switches associated with blender operation. To then toggle the switch or switches, the blender jar assembly may be pushed downwardly, or a different suitable force may be applied, to operate the blender. In this manner, a blender may be pulsed while engagement members such as tabs are retained by slots in the blender base.

### FIELD OF THE INVENTION

Aspects herein generally relate to food processing equipment such as blenders. More specifically, aspects herein relate to connecting a blender jar to a blender base, and operation of the blender.

### DISCUSSION OF RELATED ART

Food processors such as blenders rotate a processing tool (e.g., a blade assembly) within a container to assembly to process food. The container is removably mountable to a blender base such that when mounted, a drive coupling on the base rotates a driven coupling on the container to rotate the processing tool. In some blenders, the container is an inverted jar having a lid which includes the driven coupling on the outside and a blade assembly attached on the inside. The container has radially-protruding tabs which are received in corresponding slots in the blender base. The container typically is moved vertically downwardly so that each tab enters through a vertical portion of a slot, followed by rotation of the container to move each tab through a horizontal portion of its corresponding slot.

### SUMMARY

According to one embodiment, an apparatus includes a blender jar having first and second engagement members. The apparatus also includes a blender base having a motor to drive a drive coupling, a jar mounting portion to receive the blender jar, and first and second engagement member receiving slots. The first and second engagement member receiving slots are configured to receive the first and second engagement members, respectively, via rotation of the blender jar relative to the base by a user such that each of the first and second engagement members moves through a lateral portion of its respective slot. The first engagement member receiving slot has a movable member within the lateral portion, the moveable member being configured to be moved by rotation of the first engagement member into the lateral portion. The apparatus includes one or more switches which are: required to be toggled to permit operation of the motor; and can be toggled by movement of a movable member in at least one of the first and second receiving slots. The movable member is arranged to retain the first engagement member in the first receiving slot without each of the one or more switches being toggled. Additional user force on the jar after the first engagement member has been retained in the first receiving slot toggles the one or more switches that are required to be toggled to permit operation of the motor.

According to another embodiment, an apparatus includes a blender jar having first and second engagement members. The apparatus also includes a blender base having a motor to drive a drive coupling, a jar mounting portion to receive the blender jar, and first and second engagement member receiving slots. The receiving slots include lateral portions configured to receive the first and second engagement members, respectively, via rotation of the blender jar relative to the base by a user such that each of the first and second engagement members moves into a lateral portion of its respective slot. The first engagement member receiving slot has a movable member within the lateral portion. The apparatus also includes one or more switches which are: required to be toggled to permit operation of the motor; and can be toggled by movement of a movable member in at least one of the first and second receiving slots. The slot and the movable member are arranged such that the first engagement member can be moved into contact with the movable member without each of the one or more switches being toggled. Additional user force on the jar after the first engagement member has been moved into contact with the movable member toggles the one or more switches that are required to be toggled to permit operation of the motor.

In a further embodiment, an apparatus includes a blender jar having first and second engagement members. The apparatus also includes a blender base having a motor to drive a drive coupling, a jar mounting portion to receive a blender jar, and first and second engagement member receiving slots. The receiving slots are configured to receive the first and second engagement members, respectively, via rotation of the blender jar relative to the base. The first receiving slot has a blocking surface which impedes movement of the first engagement member in a jar release direction after the first engagement member is received in the slot, the blocking surface being transverse to the release direction. The blender base includes a switch which can be toggled by movement of an engagement member in a receiving slot. Toggling of the switch is required to permit actuation of the motor.

In still another embodiment, an apparatus includes a blender jar having first and second engagement members, and a blender base. The blender base includes a motor to drive a drive coupling, a jar mounting portion to receive a blender jar, and first and second engagement member receiving slots configured to receive the first and second engagement members of the blender jar, respectively. The blender base includes a switch which is toggled when an engagement member receiving slot receives and fully engages with an engagement member of the blending jar. Toggling of the switch is required to permit the blender base to actuate the motor. The first receiving slot includes a first slot contact surface. The first engagement member has an engagement member contact surface which slides along the first slot contact surface as the engagement member travels in an engagement direction within the slot when the jar is being mounted to the base via rotation of the jar relative to the base. The first engagement member contact surface is transverse to the engagement direction and/or the first slot contact surface is transverse to the engagement direction.

According to yet another embodiment, a method of operating a blender is disclosed. The blender includes a blender jar with engagement members, and a blender base having a motor and receiving slots to receive the engagement members. The method includes aligning the engagement members with the receiving slots, and rotating the blender jar to move the engagement members within lateral portions of the receiving slots without turning on the motor or placing the blender in a condition where the motor can be turned on without further movement of the blender jar. The method also includes pressing on the blender jar to turn on the motor or to place the blender in a condition where the motor can be turned on without further movement of the blender jar.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. Various embodiments of the invention will now be described, by way of example, with reference to the accompanying drawings, in which:

FIG. 1 is a perspective view of a blender jar assembly according to one embodiment;

FIG. 2 shows the blender jar assembly of FIG. 1 mounted to blender base according to one embodiment;

FIG. 3 shows a jar mounting portion of the blender base of FIG. 2;

FIG. 4 shows a jar engagement region of the blender base according to one embodiment;

FIG. 5 shows the jar engagement region with a jar engagement member engaged with the blender base, according to one embodiment;

FIG. 6 shows an alternative embodiment of a jar assembly;

FIG. 7 shows an alternative embodiment of a jar mounting portion of a blender base; and

FIG. 8 shows an alternative embodiment of a jar engagement region of the blender base.

### DETAILED DESCRIPTION

Typical blenders include a container that is mountable to a blender base, and may include a user interface to start the blender. Some blenders are started simply by placing the container on the base and pressing downwardly on the container. One example of such a blender is the type of blender that is often referred to as a personal blender or a single-serve blender.

One type of a typical personal blender includes an inverted jar assembly that has radially protruding tabs at an outer edge of the area that is mounted to the blender base. The user aligns the tabs with vertical slots in the blender base, and presses downwardly on the jar assembly to depress spring-biased plungers in the blender base, which activates the blender motor by toggling one or more switches in the blender base. In this manner, the user can pulse the blender on and off by pressing the jar downwardly and then releasing pressure until the spring-biased plungers rebound and toggle the switches to turn off the blender.

Some personal blenders allow for extended operation without constant user pressure on the jar assembly. For example, as before, the user aligns the tabs with vertical slots in the blender base, and presses downwardly on the jar assembly to depress spring-biased plungers in the blender base. The user then rotates the jar assembly such that the tabs travel through a lateral slot. An upper wall of the slot keeps the tabs positioned such that they sufficiently depress the plungers to keep the blender running, and the spring-biased plungers press against the tabs which increases the friction between the tabs and the slot, thereby helping retain the tabs in the slot.

The inventors have recognized that when pushing and releasing the jar assembly to pulse a personal blenders, the jar can feel wobbly as it is not restrained from movement out of the vertical slots. However, in blenders that allow a rotation which can better engage the jar assembly with the blender base, short pulsing cannot be achieved because the blender cannot be pulsed in the rotated, engaged position. Embodiments disclosed herein are directed to permitting pulsing with a more positively engaged jar assembly. In some embodiments, by positioning tabs or other movable members within a lateral portion of a slot, the blender base may have an improved holding of the tabs and therefore the blender jar.

Additionally, embodiments disclosed herein provide tactile and/or audible feedback to the user that the jar assembly has engaged with the blender base. For example, when the jar assembly is rotated into an engagement position, a depressible plunger may at least partially rebound and strike a surface of an engagement tab, thereby making a noise and/or allowing the user to feel the resulting vibration in the jar.

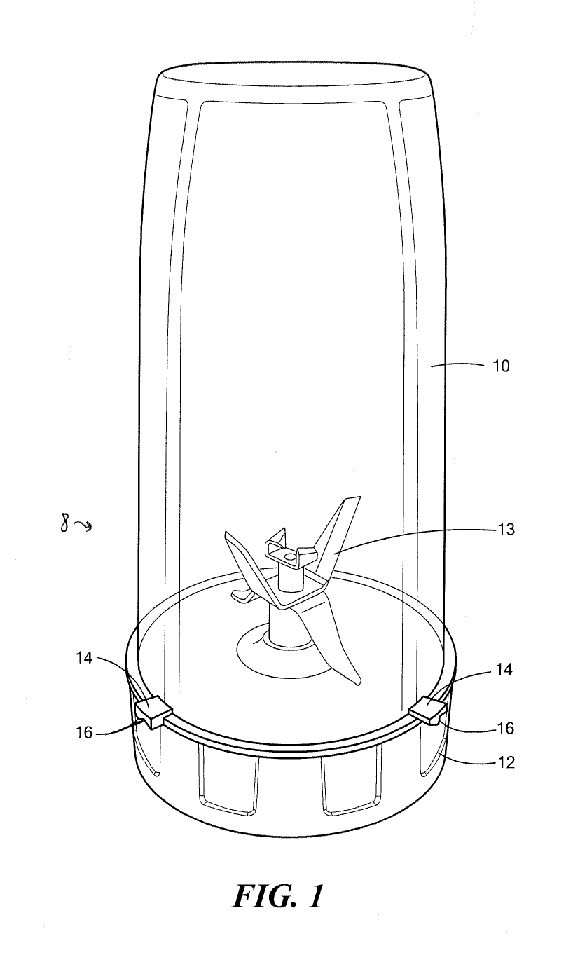

FIG. 1 shows a jar assembly 8 including a jar 10 and a jar base 12 which is removably attachable to jar 10 with threads (not shown). Jar 10 includes four equally spaced engagement members (only two are show in FIG. 1), which in this embodiment are tabs 14, though any suitable type and/or number of engagement members may be used. In some embodiments, the tabs or other engagement members extends from jar base 12 instead of jar 10. As discussed further below, one or more of tabs 14 includes a concave region 16.

A processing assembly, such as blades 13, is positioned within jar 10 when jar base 12 is attached to the jar. A driven coupling (not shown) is positioned on the outside of jar base 12 so that the blades can be rotated.

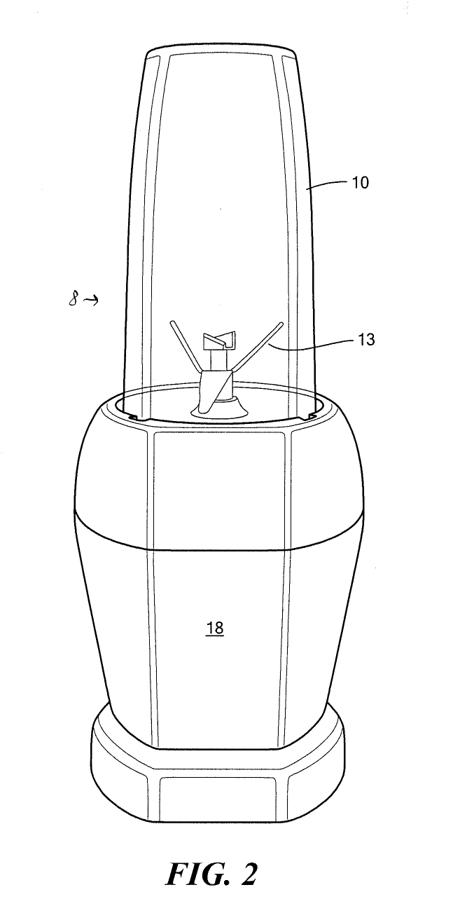

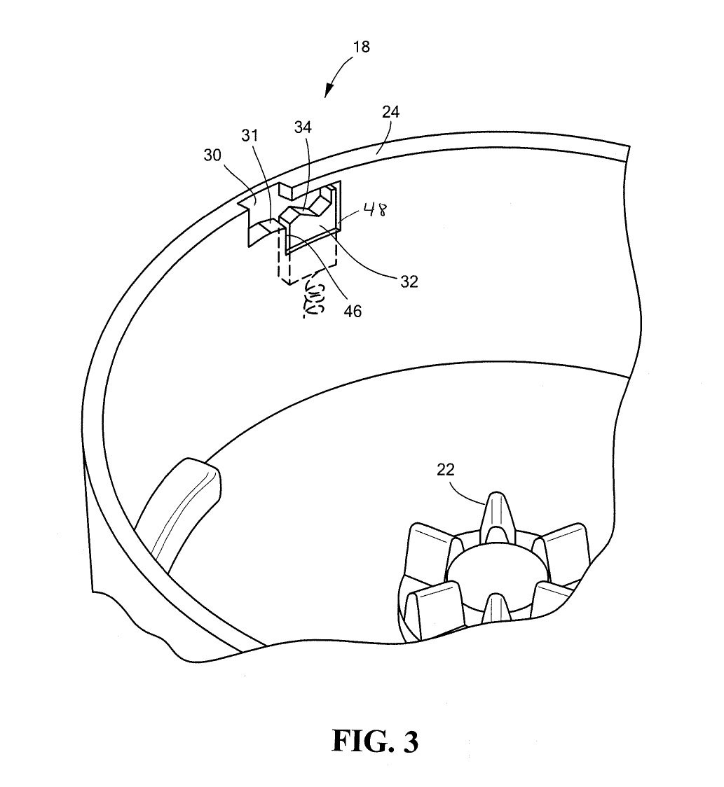

Jar assembly 8 is shown in FIG. 2 mounted to a blender base 18. Blender base 18 includes a motor which rotates a drive coupling 22 (see FIG. 3), which in turn rotates the blades 13 via the driven coupling on jar base 12. An inverted jar assembly is not the only type of jar that can be used with embodiments disclosed herein. For example, one type of jar assembly which may be used is a blender container having an opening and a lid at a top of the container, and a driven coupler on the underside of the bottom of the container. In such an embodiment, the container may have protruding tabs at the bottom of the container. Any suitable type of jar may be used with embodiments disclosed herein.

FIG. 3 shows a jar mounting portion including an upstanding collar 24 having engagement member receiving slots 30. Each slot 30 corresponds with the spacing of tabs 14 on the jar. When the tabs are aligned with the slots, the tabs may be moved to the bottom of the slots and rest on a floor surface 31.

Slots 30 include a lateral portion into which tabs 14 can travel when the jar is rotated. As the tabs travel in an engagement direction into these lateral portions, one or more of the tabs may depress a plunger 32. The interaction of the plunger and the tab may retain the tab in the slot, provided tactile feedback to the user, and/or toggle a switch in various embodiments. A wall 46 may block rotation of the tab out of a second vertical section 48 of the slot when the plunger is sufficiently depressed.

The lateral portion of a slot need not be horizontal. For example, a slot may be slanted relative to the top and/or bottom of the blender base and/or collar, and still be considered to be a lateral portion of the slot.

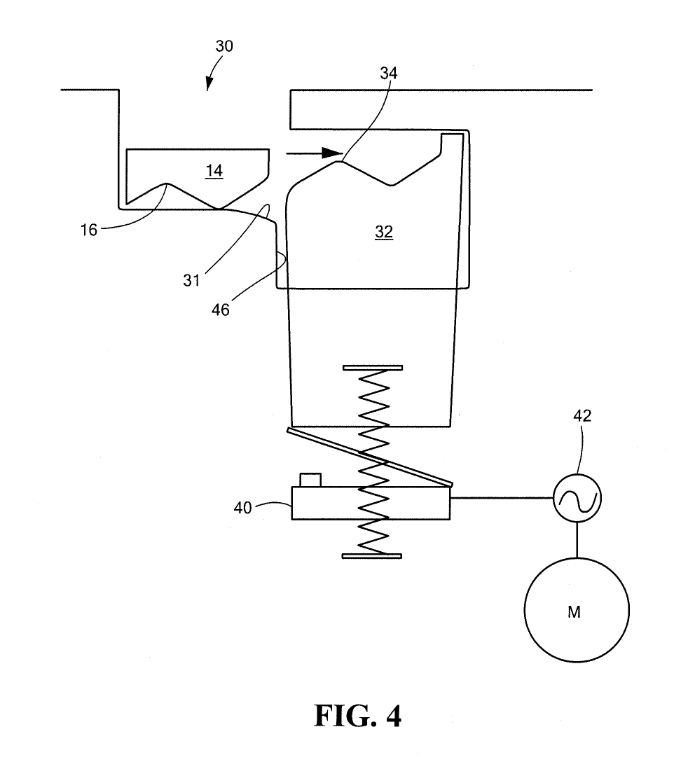

FIG. 4 is a schematic diagram of one embodiment of a tab, plunger and switch arrangement which permits the tab and plunger to engage without toggling the switch. A switch 40 may be provided which activates a motor M by allowing electricity to be deliver to the motor. In some embodiments, toggling of switch 40 may be necessary but not sufficient for starting the motor. For example, with switch 40 toggled by plunger 32, a further step of pressing a button on the blender base may be required before the blender starts. Or two or more switches may be required to be toggled by separate plungers before the blender turns on or is permitted to be turned on by additionally pressing a button or other action.

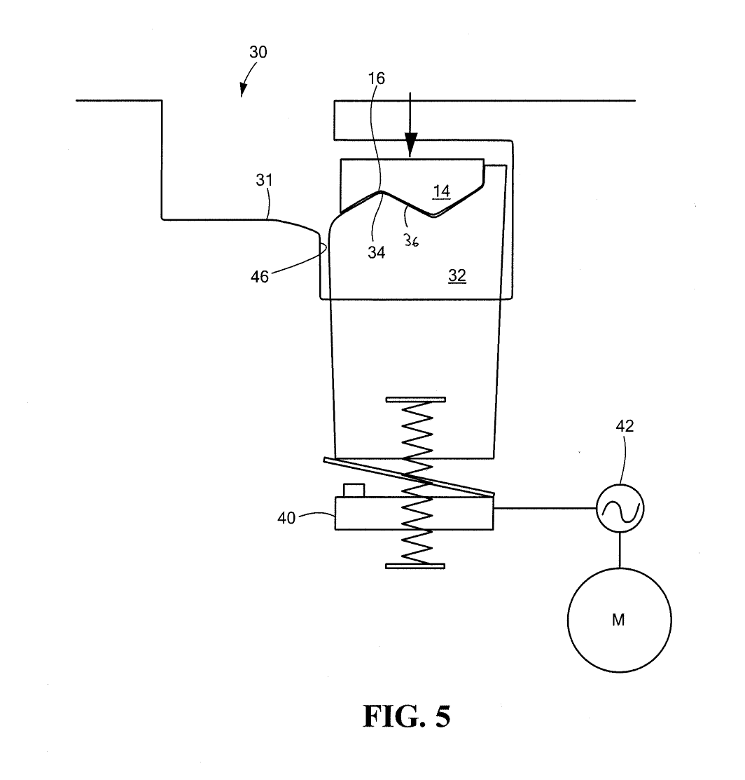

In the embodiment shown in FIGS. 4 and 5, tab 14 can be engaged with plunger 32 without toggling switch 40. For example, as shown in FIG. 5, tab 14 has been moved in an engagement direction to engage with an upper surface of plunger 32, but switch 40 has not been toggled. To toggle switch 40, the user presses down on the jar assembly until switch 40 is toggled. When in the depressed position, tab 14 may be blocked from moving in a release direction by wall 46. Even without a wall such as wall 46 blocking tab 14, or when tab 14 is in the position shown in FIG. 5, contact surfaces on plunger 32 may help retain tab 14 in the slot. For example, a convex region 34 includes a slanted blocking surface 36 which impedes movement of the concave region 16 of tab 14 in the release direction.

The terms “toggling”, “toggled”, and “toggle” are intended to be broadly construed for purpose herein. For example, toggling a switch does not require that a toggle switch or any other specific type of switch be used. For example, a momentary switch, a normally closed switch, a normally open switch, or any other suitable switch may be used such that a switch may be toggled by movements or forces applied to components of a blender. Additionally, toggling a switch is intended to include any action which changes the state of a switch, regardless of whether the change is from open to closed, closed to open, or some other suitable condition change. The term “switch” is also intended to include microprocessor controls or any other controls that involve a logic operation that responds to a change in a physical condition of any part of the blender. For example, the blender base may include an optical sensor that senses the movement of a plunger. The sensor may signal a microprocessor, which then turns on the motor. Such a sequence of events is intended to be included in the meaning of toggling a switch.

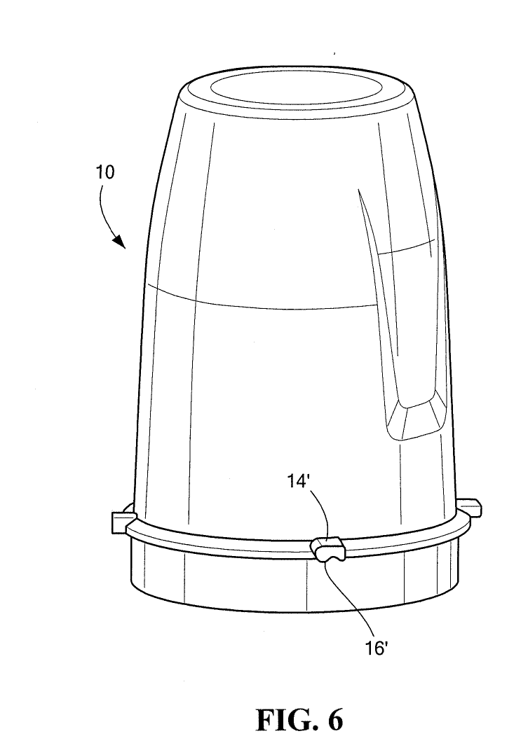

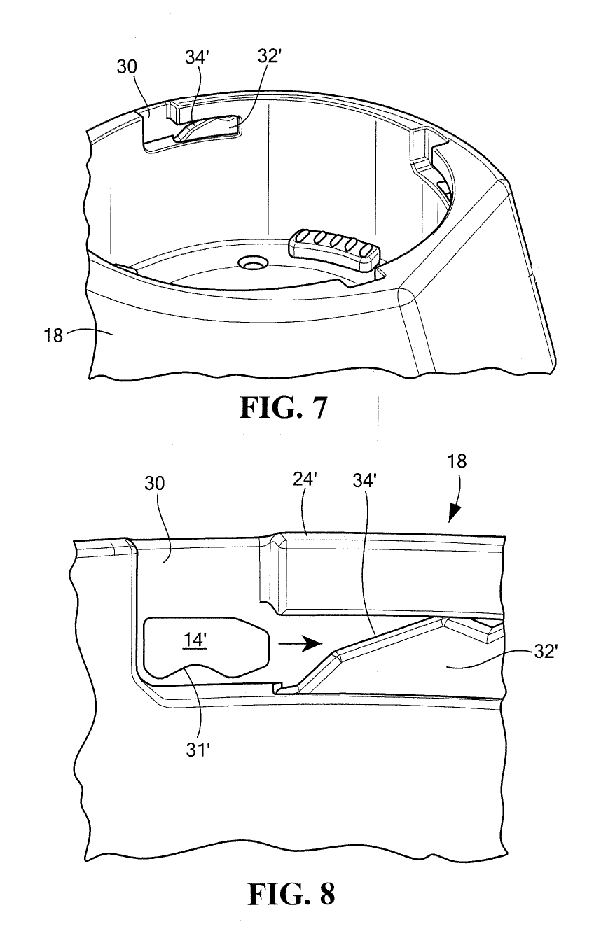

An engagement member having a different shape is shown in the embodiment of FIG. 6. A tab 14′ has a concave region 16′ which is more rounded than tab 14. Tab 14′ may have a height that occupies a significant portion of the receiving slot height such that the associated movable member, such as a depressible plunger 32′ (see FIGS. 7 and 8), is depressed and held down when tab 14′ is moved into a lateral portion of the slot (e.g., by movement in the direction of the arrow of FIG. 8). With an upper surface of tab 14′ contacting an upper surface of the later slot portion, plunger 32′ is held depressed even if the user removes downward pressure from the jar assembly. In this manner, the plunger may be held in a depressed position to operate the blender for an extended period of time.

The plunger 32′ shown in FIGS. 7 and 8 has a different shape as compared to the embodiment shown in FIGS. 3-5. The rising, leading surface has two distinct slopes. In some embodiments, the upper surface or other contact surfaces of the plunger or other movable member may be curved instead of linear, or may include both linear and curved surfaces.

In some embodiments, the tabs may have convex regions while the depressible plungers have concave regions. In still other embodiments, the tabs and/or depressible plungers may not be either convex or cave. For example, in one embodiment, a tab may be rectangular in cross-section, and the upper surface of a plunger may have an entirely horizontal surface, or may have a leading edge with a slope and a flat surface where the tab ultimately rests on top of the plunger.

While in some embodiments a surface transverse to the release direction impedes release of the tab from the slot portion containing the plunger or other movable member, in other embodiments, friction may be the only impediment to release. For example, according to some embodiments, the slots and tabs may be arranged such that a tab can be moved laterally along the slot to a position on top of the plunger without depressing the plunger at all, or only slightly depressing the plunger. To activate the blender, the user then pushes downwardly on the blender jar to depress the plunger. In this sense, the term “engagement member” is not intended to necessarily require that the member be restrained from moving away from the associated movable member. Instead, the engagement may engage with the movable member only by pressing against the movable member to move the member (e.g., a tab pushing against a plunger to depress the plunger). In some embodiments, the spring bias of the plunger may press the tab against an upper surface of the slot without the plunger activating a switch.

The movable members of a blender base need not all have the same function as one another. For example, a first tab may depress a spring-biased plunger which toggles a switch that is required to be toggled for the blender motor to be activated, while other tabs depress spring-biased plungers which are not associated with any switches. One tab may depress a plunger to toggle a switch to activate a user interface in some embodiments.

In some embodiments, a plunger or other movable member may move upwardly relative to the blender base when presses by an engagement member. In such an embodiment, the plunger may be biased downwardly by a spring. Biasing elements other than springs may be used to bias movable members in various embodiments.

The above described components may be made with various materials, as the invention is not necessarily so limited. The above aspects may be employed in any suitable combination, as the present invention is not limited in this respect. Additionally, any or all of the above aspects may be employed in any suitable food processing apparatus.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. An apparatus comprising:
a blender jar having first and second engagement members; and
a blender base including:
a motor to drive a drive coupling;
a jar mounting portion to receive the blender jar;
first and second engagement member receiving slots configured to receive the first and second engagement members, respectively, via rotation of the blender jar relative to the base by a user such that each of the first and second engagement members moves through a lateral portion of its respective slot;
the first engagement member receiving slot having a movable member within the lateral portion, the moveable member being configured to be moved by rotation of the first engagement member into the lateral portion; and
one or more switches which are: required to be toggled to permit operation of the motor; and can be toggled by movement of a movable member in at least one of the first and second receiving slots;
wherein
the movable member is arranged to retain the first engagement member in the first receiving slot without each of the one or more switches being toggled; and
additional user force on the jar after the first engagement member has been retained in the first receiving slot toggles the one or more switches that are required to be toggled to permit operation of the motor.

2. An apparatus as in claim 1, wherein the blender base is arranged such that additional user force on the jar pushes the movable member, and the resulting movement of the movable member toggles a switch of the one or more switches that are required to be toggled to permit operation of the motor.

3. An apparatus as in claim 1, wherein the blender base is arranged such that the additional user force on the jar pushes a movable member positioned in the second receiving slot, and the movable member in the second receiving slot toggles a switch of the one or more switches that is required to be toggled to permit operation of the motor.

4. An apparatus as in claim 1, wherein the first receiving slot has a blocking surface which impedes movement of the first engagement member in a jar release direction when the first engagement member is retained in the slot, the blocking surface being transverse to the release direction.

5. An apparatus as in claim 4, wherein the blocking surface is on the movable member.

6. An apparatus as in claim 5, wherein the blocking surface is slanted relative to the jar release direction.

7. An apparatus as in claim 1, wherein the movable member is a biased, depressible plunger, and the first engagement member and the depressible plunger are arranged such that movement of the first engagement member from a released position to a retained position provides tactile feedback to a user holding the blender jar, once the retained positioned is reached.

8. An apparatus as in claim 7, wherein the tactile feedback is provided by the depressible plunger at least partially rebounding to a non-depressed position.

9. An apparatus as in claim 1, wherein the movable member is a biased, depressible plunger having a contact surface with a concave or a convex region, the contact surface being arranged to contact the first engagement member.

10. An apparatus as in claim 9, wherein the first engagement member has a contact surface with the other of a concave or a convex region, the contact surface of the first engagement member being arranged to contact the depressible plunger.

11. An apparatus as in claim 1, wherein the first engagement member is movable in the receiving slot toward the movable member in an engagement direction, and the movable member is a biased, depressible plunger having a contact surface with a leading edge that is slanted relative the engagement direction, the contact surface being arranged to contact the first engagement member.

12. An apparatus as in claim 1, wherein the first engagement member is movable in the receiving slot toward the movable member in an engagement direction, and the first engagement member has a contact surface with a leading edge that is slanted relative the engagement direction, the contact surface being arranged to contact the movable member in the receiving slot.

13. An apparatus comprising:
a blender jar having first and second engagement members; and
a blender base including:
a motor to drive a drive coupling;
a jar mounting portion to receive the blender jar;
first and second engagement member receiving slots including lateral portions configured to receive the first and second engagement members, respectively, via rotation of the blender jar relative to the base by a user such that each of the first and second engagement members moves into a lateral portion of its respective slot;
the first engagement member receiving slot having a movable member within the lateral portion; and
one or more switches which are: required to be toggled to permit operation of the motor; and can be toggled by movement of a movable member in at least one of the first and second receiving slots;
wherein
the slot and the movable member are arranged such that the first engagement member can be moved into contact with the movable member without each of the one or more switches being toggled; and
additional user force on the jar after the first engagement member has been moved into contact with the movable member toggles the one or more switches that are required to be toggled to permit operation of the motor.

14. An apparatus comprising:
a blender jar having first and second engagement members; and
a blender base including:
a motor to drive a drive coupling;
a jar mounting portion to receive a blender jar; and
first and second engagement member receiving slots configured to receive the first and second engagement members, respectively, via rotation of the blender jar relative to the base; wherein
the first receiving slot has a blocking surface which impedes movement of the first engagement member in a jar release direction after the first engagement member is received in the slot, the blocking surface being transverse to the release direction;
the blender base includes a switch which can be toggled by movement of an engagement member in a receiving slot; and
toggling of the switch is required to permit actuation of the motor.

15. An apparatus as in claim 14, further comprising a depressible plunger, wherein the plunger is depressed by contact of the first engagement member against the plunger, and the blocking surface is on the plunger.

16. An apparatus as in claim 15, wherein depression of the plunger toggles the switch.

17. An apparatus as in claim 15, wherein the plunger is biased to push against the first engagement member, and the blocking surface comprises a surface that is slanted relative to the release direction.

18. An apparatus as in claim 14, wherein the movable member is a biased, depressible plunger, the first engagement member and the depressible plunger are arranged such that movement of the first engagement member from a released position to a retained position provides tactile feedback to a user holding the blender jar once the retained positioned is reached, and the tactile feedback is provided by the depressible plunger striking the first engagement member when at least partially rebounding from being depressed.

19. An apparatus comprising:
a blender jar having first and second engagement members; and
a blender base including:
a motor to drive a drive coupling;
a jar mounting portion to receive a blender jar;
first and second engagement member receiving slots configured to receive the first and second engagement members of the blender jar, respectively;
a switch which is toggled when an engagement member receiving slot receives and fully engages with an engagement member of the blending jar; wherein
toggling of the switch is required to permit the blender base to actuate the motor;
the first receiving slot includes a first slot contact surface;
the first engagement member has an engagement member contact surface which slides along the first slot contact surface as the engagement member travels in an engagement direction within the slot when the jar is being mounted to the base via rotation of the jar relative to the base; and
the first engagement member contact surface is transverse to the engagement direction and/or the first slot contact surface is transverse to the engagement direction.

20. An apparatus as in claim 19, further comprising a depressible plunger, wherein the plunger is depressed away from a first position by contact of the first engagement member against the slot contact surface as the first engagement member moves in the engagement direction.

21-28. (canceled)
